(19) United States
(12) Patent Application Publication
(10) Pub. No.: US 2026/0048389 A1
(43) Pub. Date: Feb. 19, 2026

(54) CROSS-FLOW FILTRATION OF SLURRY CATALYST IN A PETROLEUM-BASED LIQUID CARRIER

(71) Applicant: Chevron U.S.A. Inc., San Ramon, CA (US)

(72) Inventors: Bo Kou, Albany, CA (US); Shuwu Yang, Richmond, CA (US); Theodorus Ludovicus Michael Maesen, Spring, TX (US); Michelle K. Young, Manvel, TX (US)

(21) Appl. No.: 19/291,803

(22) Filed: Aug. 6, 2025

Related U.S. Application Data
(60) Provisional application No. 63/683,367, filed on Aug. 15, 2024.

(51) Int. Cl. B01J 37/00; B01J 31/02; B01J 35/27; B01J 38/52

(52) U.S. Cl. CPC B01J 37/009; B01J 31/0202; B01J 35/27; B01J 38/52

(57) ABSTRACT

A process including converting, in one or more cross-flow filtration separation units, a slurry catalyst containing solid particles and a petroleum-based oil liquid carrier to a slurry catalyst comprising solid particles and a renewable-based liquid carrier. The slurry catalyst containing solid particles and the renewable-based liquid carrier includes less than about 5 wt. % of the petroleum-based oil liquid carrier.

### PRIORITY CLAIM

The present application claims priority to U.S. Provisional Patent Application No. 63/683,367, entitled “Cross-Flow Filtration of Slurry Catalyst in a Petroleum-Based Liquid Carrier,” filed Aug. 15, 2024, the content of which is incorporated by reference herein in its entirety.

### BACKGROUND

Slurry hydroconversion processes such as slurry hydrocracking processes have been used for the upgrading of heavy hydrocarbon feedstocks to produce distillate products. In slurry hydrocracking processes, these feedstocks are converted in the presence of hydrogen and solid catalyst particles. The slurry catalyst compositions can be used with a liquid carrier to assist in transporting it in the slurry hydrocracking processes. The liquid carriers used can be heavy oils produced during the slurry hydrocracking processes.

Due to environment regulations, governmental regulations and incentives, and an increasing worldwide demand for energy, there is an increasing emphasis on replacing petroleum-based feedstocks with renewable-based feedstocks. Currently, refineries are interested in processing renewable-based liquid carriers such as vegetable oil and animal oil. Refineries are processing renewable-based liquid carriers in existing refinery units to minimize the installation and operational cost and reduce the revamp requirement.

### SUMMARY

In accordance with an illustrative embodiment, a process comprises:
converting, in one or more cross-flow filtration separation units, a slurry catalyst comprising solid particles and a petroleum-based oil liquid carrier to a slurry catalyst comprising solid particles and a renewable-based liquid carrier, wherein the slurry catalyst comprising solid particles and the renewable-based liquid carrier comprises less than about 5 wt. % of the petroleum-based oil liquid carrier.

In accordance with another illustrative embodiment, a continuous process for converting an incoming slurry catalyst comprising solid particles and a petroleum-based oil liquid carrier to a slurry catalyst comprising solid particles and a renewable-based liquid carrier, comprises:
generating, in a last diafiltration separation unit of a series of diafiltration separation units comprising three to five diafiltration separation units, a first retentate comprising the slurry catalyst comprising solid particles and a first amount of the renewable-based liquid carrier and a permeate comprising a mixture of the petroleum-based oil liquid carrier and a second amount of the renewable-based liquid carrier,
wherein the generating comprises passing, through the last diafiltration separation unit, a pressurized stream comprising (i) a second retentate derived from the other diafiltration separation units, the second retentate comprising the slurry catalyst comprising solid particles and a reduced content of the petroleum-based oil liquid carrier relative to the incoming slurry catalyst comprising solid particles and the petroleum-based oil liquid carrier, (ii) a recycled retentate comprising a portion of the first retentate comprising the slurry catalyst comprising solid particles and the first amount of the renewable-based oil liquid carrier received from the last diafiltration separation unit and (iii) an incoming stream comprising the renewable-based liquid carrier to generate the first retentate.

In accordance with yet another illustrative embodiment, a system comprises:
one or more cross-flow filtration separation units configured to convert a slurry catalyst comprising solid particles and a petroleum-based oil liquid carrier to a slurry catalyst comprising solid particles and a renewable-based liquid carrier, wherein the slurry catalyst comprising solid particles and the renewable-based liquid carrier comprises less than about 5 wt. % of the petroleum-based oil liquid carrier.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated herein by way of example but not limitation. The principles illustrated in the example embodiments of the drawings can be applied to alternate processes and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements. In the accompanying drawings:

FIG. 1 illustrates a schematic diagram of a process for converting a slurry catalyst comprising solid particles and a petroleum-based oil liquid carrier to a slurry catalyst comprising solid particles and a renewable-based liquid carrier using a diafiltration separation system in countercurrent mode based on the petroleum-based oil liquid carrier having a boiling point greater than the boiling point of the renewable-based liquid carrier, according to an illustrative embodiment.

FIG. 2 illustrates a schematic diagram of a process for converting a slurry catalyst comprising solid particles and a petroleum-based oil liquid carrier to a slurry catalyst comprising solid particles and a renewable-based liquid carrier using a diafiltration separation system in countercurrent mode and a liquid-liquid separator based on a density difference between the petroleum-based oil liquid carrier and the renewable-based liquid carrier, according to an illustrative embodiment.

### DETAILED DESCRIPTION

Various illustrative embodiments described herein are directed to processes for converting a slurry catalyst comprising solid particles and a petroleum-based oil liquid carrier to a slurry catalyst comprising solid particles and a renewable-based liquid carrier using a diafiltration separation system. The conversion of a slurry catalyst comprising solid particles and a petroleum-based oil liquid carrier to a slurry catalyst comprising solid particles and a renewable-based liquid carrier offers one alternative to crude.

As discussed above, hydroconversion processes such as slurry hydrocracking processes have been used for the upgrading of heavy hydrocarbon feedstocks to produce distillate products. In slurry hydrocracking processes, these feedstocks are converted in the presence of hydrogen and solid catalyst particles. The slurry catalyst compositions can be used with a liquid carrier to assist in transporting it in the slurry hydrocracking processes. The liquid carriers used can be heavy oils produced during the slurry hydrocracking processes. For example, a slurry catalyst from, for example, a slurry hydroconversion process, is prepared in a fossil-based carrier, e.g., a petroleum-based oil such as a vacuum gas oil. However, since refineries are becoming more interested in processing renewable feedstocks rather than petroleum-based feedstocks, it can be critical to eliminate petroleum-based feedstocks, including petroleum-based liquid carriers from the slurry catalyst.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “hydroconverting” or “hydroconversion,” as used herein refers to any process in which hydrocarbons are processed or treated in the presence of a hydrogen stream and a catalyst. Representative examples of hydroconverting include hydrocracking, hydrotreating, hydrogenation, deoxygenation, desulfurization, denitrogenation, demetallization, dechlorination, decarboxylation, decarbonylation, dearomatization or a combination thereof.

The term “hydrocracking,” as used herein, refers to a process in which hydrocarbons crack in the presence of a hydrogen stream to lower molecular weight hydrocarbons. Hydrocracking also includes slurry hydrocracking in which feed is mixed with catalyst and hydrogen to make a slurry and cracked to lower boiling products.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

The term “renewable” refers to a material that is produced from a renewable resource, which is a resource produced via a natural process at a rate comparable to its rate of consumption (e.g., within a 100-year time frame). The renewable resource can be replenished naturally or via agricultural techniques. Non-limiting examples of renewable resources include plants, animals, fish, bacteria, fungi, and forestry products. These resources can be naturally occurring, hybrids, or genetically engineered organisms. Natural resources such as crude oil (petroleum), natural gas, coal, peat, etc. take longer than 100 years to form and thus they are not considered renewable resources.

The term “effluent” refers to a stream that is passed out of a reactor, a reaction zone, or a separator following a particular reaction or separation. Generally, an effluent has a different composition than the stream that entered the reactor, reaction zone, or separator. It should be understood that when an effluent is passed to another component or system, only a portion of that effluent may be passed. For example, a slipstream may carry some of the effluent away, meaning that only a portion of the effluent may enter the downstream component or system.

The term “separation unit” refers to any separation device that at least partially separates one or more chemicals in a mixture from one another. For example, a separation unit may selectively separate different chemical species from one another, forming one or more chemical fractions. Examples of separation units include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation. As used in this disclosure, one or more chemical constituents may be “separated” from a process stream to form a new process stream. Generally, a process stream may enter a separation unit and be divided or separated into two or more process streams of a desired composition.

The non-limiting illustrative embodiments described herein overcome the drawbacks discussed above by providing processes for converting a slurry catalyst comprising solid particles and a petroleum-based oil liquid carrier to a slurry catalyst comprising solid particles and a renewable-based liquid carrier using one or more cross-flow filtration separation units such as one or more diafiltration separation unit. The process therefore can obtain a slurry catalyst comprising solid particles and a renewable-based liquid carrier having little to no petroleum based liquid carrier. The process therefore may obtain a slurry catalyst comprising solid particles and a renewable-based liquid carrier as the only liquid carrier thereby avoiding the use of a petroleum based liquid carrier. The slurry catalyst in the renewable-based liquid carrier can then be used in a slurry process using a renewable feedstock to produce renewable fuels without any contamination from a petroleum product. In addition, the petroleum based liquid carrier removed during the conversion process can be reused to make a new catalyst. Therefore, the carbon emission of the entire process will be much lower.

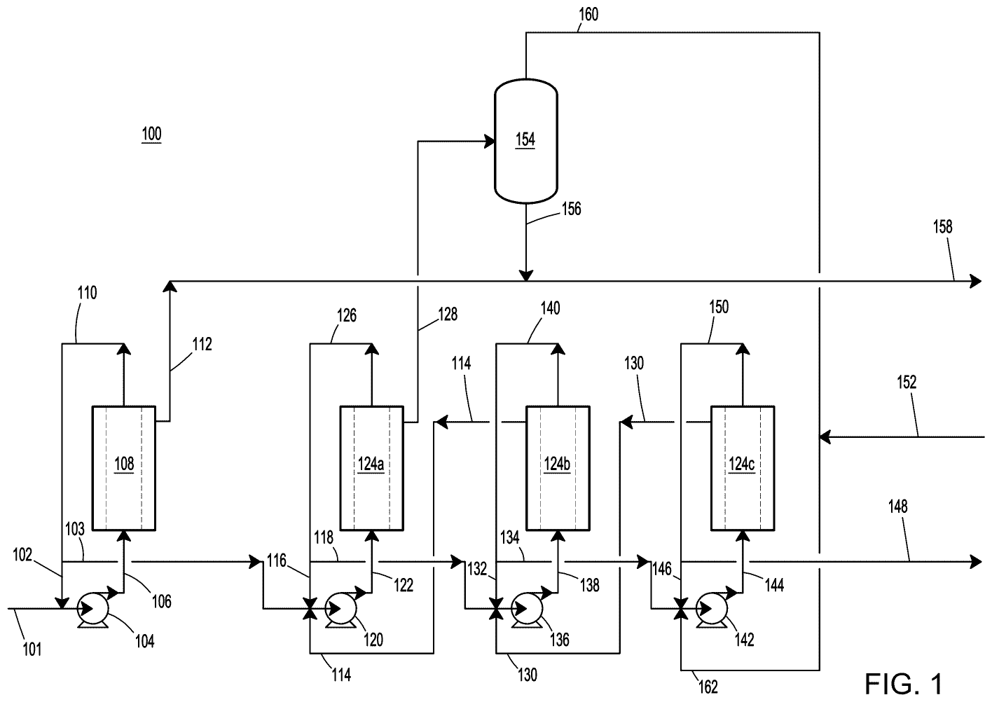

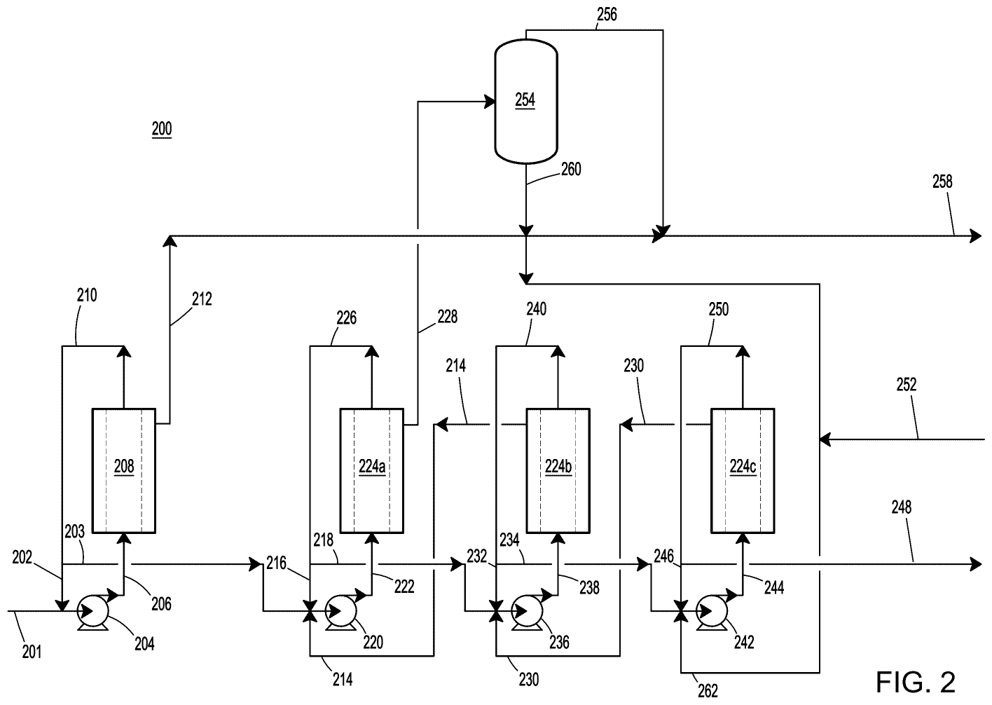

The non-limiting illustrative embodiments of the present disclosure will be specifically described below with reference to the accompanying drawings. For the purpose of clarity, some steps leading up to the production of a slurry catalyst comprising solid particles and a renewable-based liquid carrier as illustrated in FIGS. 1 and 2 may be omitted. In other words, one or more well-known processing steps which are not illustrated but are well-known to those of ordinary skill in the art have not been included in the figures. This is not intended to be interpreted as a limitation of any particular embodiment, or illustration, or scope of the claims.

Referring now to the drawings in more detail, FIG. 1 illustrates a system 100 according to illustrative embodiments of the invention. In this particular embodiment, a petroleum-based oil liquid carrier present in an incoming slurry catalyst stream 101 as discussed below can be mixed with a renewable-based liquid carrier present in an incoming renewable-based liquid carrier stream 152 during the conversion process utilizing one or more diafiltration separation units as discussed below. System 100 includes at least an optional solid-liquid separation unit 108, diafiltration separation units 124a, 124b and 124c and pumps 104, 120, 136 and 142. It is to be understood that system 100 including at least optional solid-liquid separation unit 108, diafiltration separation units 124a, 124b and 124c and pumps 104, 120, 136 and 142 is not limited to the configuration of the embodiments shown in FIG. 1, and other configurations are contemplated herein. In particular, although three diafiltration separation units and three pumps are shown in system 100, this is merely illustrative and other configurations are contemplated herein. For example, in non-limiting illustrative embodiments, system 100 may contain from one to five diafiltration separation units. In addition, it is further contemplated that in some embodiments, system 100 may not include optional solid-liquid separation unit 108.

In some embodiments, incoming slurry catalyst stream 101 including a petroleum-based oil liquid carrier can contain from about 60 wt. % to about 98 wt. % petroleum-based oil liquid carrier and from about 2 wt. % to about 40 wt. % spent catalyst (as solids, in the form of slurry catalyst). In some embodiments, incoming slurry catalyst stream 101 is received from a separation unit (not shown) following a slurry hydroconversion process in a slurry hydroconversion reactor unit including at least a heavy oil feedstock, or directly from a slurry hydroconversion reactor unit. In general, a slurry hydroconversion process uses a dispersed catalyst which can be continuously doped into the feed. In some embodiments, the catalyst can correspond to one or more catalytically active metals in particulate form and/or supported on particles. In some embodiments, the slurry hydroconversion catalyst may be a precursor thereof.

In some embodiments, the slurry catalyst is generally provided in the form of fine particulates dispersed within the reactor liquid reaction medium and may be a supported catalyst, an unsupported catalyst, or a combination thereof. In some embodiments, the slurry catalyst comprises a metal selected from Group VIB, Group VIII of the Periodic Table, or a combination thereof. The slurry catalyst may be unsulfided or pre-sulfided before being added to the reactor. The slurry catalyst can comprise one or more different slurry catalysts as a single combined feed stream or as separate feeds to the reactor. In some embodiments, the slurry catalyst may have an average particle size of at least about 0.1 micron to about 200 microns. In some embodiments, the slurry catalyst may have an average particle size of at least about 0.1 micron to about 100 microns, e.g., from about 1 to about 10 microns. In some embodiments, the slurry catalyst comprises a metal sulfide comprising one or more metals selected from the group consisting of molybdenum, nickel, cobalt and tungsten, and the slurry catalyst comprises particles having an average particle size of about 0.1 micron to about 200 microns. However, the slurry catalyst described above is merely illustrative and any known slurry catalyst or later developed slurry catalyst is contemplated in the embodiments described herein.

The slurry catalyst further includes a petroleum-based oil liquid carrier and co-catalyst particles. The co-catalyst particles may be in admixture with the petroleum-based oil liquid carrier. In some embodiments, the petroleum-based oil liquid carrier may have a boiling range greater than 500° F., e.g., greater than 500° F. and up to about 1125° F., or from about 550° F. to about 1100° F., or from about 550° F. to about 950° F. In some embodiments, at least 90% or at least 95% of the petroleum-based oil liquid carrier may have a boiling range greater than 500° F., e.g., greater than 500° F. and up to about 1125° F., or from about 550° F. to about 1100° F., or from about 550° F. to about 950° F. Suitable petroleum-based oil liquid carriers include, for example, vacuum gas oil, light vacuum gas oil, heavy vacuum gas oil, lube oil base stock, heavy diesel, and combinations thereof.

Incoming slurry catalyst stream 101 including a petroleum-based oil liquid carrier is combined with a second slurry catalyst stream 102 received from optional solid-liquid separation unit 108 as discussed below for sending to a pump 104. Pump 104 can be any suitable pump for increasing the pressure of incoming slurry catalyst stream 101 and second slurry catalyst stream 102 for sending a first pressurized slurry catalyst stream 106 to optional solid-liquid separation unit 108. For example, pump 104 may be a centrifugal pump, a rotary pump including an impeller, or alternatively may be any other suitable fluid pump. In some embodiments, pump 104 is a large recirculation pump for providing crossflow filtration.

Optional solid-liquid separation unit 108 separates first pressurized slurry catalyst stream 106 including a petroleum-based oil liquid carrier to provide a first slurry catalyst stream 110 having a reduced content of petroleum-based oil liquid carrier (i.e., a solid-rich stream comprising solid catalyst particles, solids formed during a hydroconversion reaction and an amount of petroleum-based oil liquid carrier) and a first petroleum-based oil liquid carrier rich effluent 112 (i.e., a solid-free lean stream). A “solid-rich stream” is intended herein to identify a liquid, slurry, or solid stream that contains most if not all the amounts of solids (e.g., 99%) contained in first pressurized slurry catalyst stream 106 entering optional solid-liquid separation unit 108. A “solid-free lean stream” is intended herein to identify a liquid or liquid stream containing negligible amounts of solids, generally lower than about 1000 ppm, or lower than about 100 ppm, e.g., from about 10 ppm to about 1000 ppm solids.

In some embodiments, the solids can be separated from first pressurized slurry catalyst stream 106 using conventional techniques such as, for example, centrifugation, sedimentation or gravity settling, filtering, or any other suitable separator or combination of separators.

In some embodiments, optional solid-liquid separation unit 108 carries out a solid-liquid separation process comprising a filtration process or step. Suitable filtration processes generally include, for example, using a mesh, screen, cross-flow filtration, backwash filtration, or a combination thereof. In some embodiments, filtration processes include membrane filtration processes (e.g., microfiltration processes, using membranes having an average pore size of less than about 10 microns, more particularly, an average pore size of less than about 5 microns, or an average pore size of less than about 2 microns). In some embodiments, the filter membrane may be composed of a material such as, for example, metals, polymeric materials, ceramics, glasses, nanomaterials, or a combination thereof. Suitable metals include, for example, stainless steel, titanium, bronze, aluminum, nickel, copper and alloys thereof. Such membranes may also be coated for various reasons, and with various materials, including inorganic metal oxides coatings.

In a non-limiting embodiment, a filtration process for use herein can be a cross-flow filtration process. “Cross-flow filtration” (or crossflow filtration or tangential flow filtration (TFF)) refers to a filtration technique in which the feed stream flows parallel or tangentially along the surface of a membrane and the filtrate flows across the membrane. In cross-flow filtration, typically only the material which is smaller than the membrane pore size passes through (across) the membrane as permeate or filtrate, and everything else is retained on the feed side of the membrane as retentate or concentrate. Thus, a cross-flow filtration process of first pressurized slurry catalyst stream 106 provides first slurry catalyst stream 110 having a reduced content of petroleum-based oil liquid carrier as an outlet retentate slurry stream which is more concentrated in term of solids and, on the other side, first petroleum-based oil liquid carrier rich effluent 112 as an outlet cleaned permeate fluid containing relatively little to no solid content. Suitable cross-flow filtration systems are well known and described in various patents such as, for example, U.S. Pat. No. 8,080,155, the contents of which are incorporated by reference herein. In some embodiments, there will also be a pump (not shown) to move first petroleum-based oil liquid carrier rich effluent 112 in countercurrent flow against the slurry catalyst flow.

In some embodiments, a membrane filtration assembly, e.g., microfiltration, is employed in a deoiling zone to separate the petroleum-based oil liquid carrier from the solid catalyst particles. The membranes employed can be of the “tortuous-pore” or “capillary-pore” type, or a combination of multiple membrane layers, some tortuous-pore membranes some capillary-pore membranes. As used herein, tortuous-pore refers to membranes having a structure resembles a sponge with a network of interconnecting tortuous pores. Capillary-pore refers to membranes having approximately straight-through cylindrical capillaries.

Any suitable filtration medium (membrane) can be utilized in the filtration assembly. In one embodiment, the filtration medium is a porous material which permits heavy oil below a certain size to flow through as the filtrate (or permeate) while retaining the spent catalyst particles in the retentate. In one embodiment, the filter medium is of sufficient pore size for removing at least 50% of the solid-free lean stream from the solid-rich stream, i.e., for at least 50% of the solid-free lean stream to pass through the filter membrane. In another embodiment, the filter membrane is of sufficient pore size for at least 60% of the solid-free lean stream to pass through the membrane. In another embodiment, the filter membrane is of sufficient pore size for at least 70% of the solid-free lean stream to pass through the membrane. In another embodiment, the filter membrane is of sufficient size for at least 75% of the solid-free lean stream to pass through the membrane.

In one embodiment, the filtration medium is a filter membrane having an effective pore rating (“average pore size”) of about 5 microns or less is used; for example, about 0.1 to about 0.3 μm, or about 0.05 to about 0.15 μm.

In some embodiments, suitable material for the construction of the membrane includes polymers, organic materials, inorganic ceramic materials, and metals, as long as they are solvent stable. The term “solvent-stable” refers to a material that does not undergo significant chemical changes to substantially impair the desired properties of the material. Stability can be verified by various well-known techniques, which include, but are not limited to, soaking test, scanning electron microscopy (SEM), X-ray diffraction (XRD), differential scanning calorimetry (DSC) and thermogravimetric analysis (TGA).

In some embodiments, the filter membrane is made of polytetrafluoroethylene (Teflon®), for example, polytetrafluoroethylene on woven fiberglass, which can withstand temperatures of 130° C. (266° F.). With the use of polytetrafluoroethylene, the membrane is chemically inert, can handle continuous pH levels of 0 to about 14.

In some embodiments, the filter membrane comprises a polymeric material such as, for example, poly(acrylic acids), poly(acrylates), polyacetylenes, poly(vinyl acetates), polyacrylonitriles, polyamines, polyamides, polysulfonamides, polyethers, polyurethanes, polyimides, polyvinyl alcohols, polyesters, cellulose, cellulose esters, cellulose ethers, chitosan, chitin, elastomeric polymers, halogenated polymers, fluoroelastomers, polyvinyl halides, polyphosphazenes, polybenzimidazoles, poly(trimethylsilylpropyne), polysiloxanes, poly(dimethyl siloxanes), and copolymers blends thereof. These polymers can be physically or chemically cross-linked to further improve their solvent stability.

In some embodiments, the filter membrane comprises an inorganic material such as, for example, ceramics (silicon carbide, zironiumoxide, titaniumoxide, etc.) having the ability to withstand high temperatures and harsh environments. In one embodiment, the filter membrane is constructed from a woven fabric coated with a nanomaterial, e.g., an inorganic metal oxide, allowing the membrane to be in the form of a flexible ceramic membrane foil with advantages of both ceramic and polymeric membranes. In another embodiment, the filter membrane is constructed from a metal such as stainless steel, titanium, bronze, aluminum or nickel-copper alloy. In yet another embodiment, the filter membrane is constructed from materials such as sintered stainless steel with an inorganic metal oxide coating, e.g., a titanium oxide coating.

In some embodiments, the deoiling zone comprises a membrane that is rapidly displaced in a horizontal direction. A retentate of the membrane comprises the solid-rich stream and a permeate of the membrane comprises the solid-free lean stream. In particular, rapidly displacing the membrane in a horizontal direction can comprise rotating the membrane.

In some embodiments, the filter membrane operating pressure is in the range of about 30 psi to about 100 psi (about 2 bar to about 7 bar). Filtering can be conducted at a temperature of about 50° C. to about 200° C. and a pressure of about 80 to about 200 psi. In some embodiments, the deoiling zone comprising multiple filtration units is operated at a pressure in the range of about 20 psi to about 400 psi, for example, about 30 psi to about 300 psi or about 50 psi to about 200 psi. Pressure drops across the membrane in the filtration units, referred to as the transmembrane pressure, are in the range of about 0 psi to about 100 psi, for example, about 0 psi to about 50 psi or about 0 psi to about 25 psi. In one embodiment, the temperature of the deoiling zone is in the range of about 100° F. to about 500° F., for example, about 150° F. to about 450° F. or about 200° F. to about 400° F.

In one embodiment, the filtration assembly comprises between two to ten filtration units. In another embodiment, at least four to eight filtration units.

In one embodiment, optional solid-liquid separation unit 108, e.g., a cross-flow filtration device, used in the illustrative embodiments described herein concentrates the solid content from an initial concentration of about 5 wt. % to about 12 wt. % of first pressurized slurry catalyst stream 106, up to about 20 wt. % to about 25% by weight of first slurry catalyst stream 110 as the outlet stream (retentate) while obtaining first petroleum-based oil liquid carrier rich effluent 112 as an outlet cleaned stream containing relatively little to no solid content. In some embodiments, first petroleum-based oil liquid carrier rich effluent 112 will contain at least about 90% of the petroleum-based oil liquid carrier relative to first pressurized slurry catalyst stream 106. In some embodiments, first petroleum-based oil liquid carrier rich effluent 112 will contain at least about 95% of the petroleum-based oil liquid carrier relative to first pressurized slurry catalyst stream 106. In some embodiments, first petroleum-based oil liquid carrier rich effluent 112 will contain at least about 99% of the petroleum-based oil liquid carrier relative to first pressurized slurry catalyst stream 106.

In some embodiments, first slurry catalyst stream 110 can contain from about 1 wt. % to about 10 wt. % petroleum-based oil liquid carrier and from about 90 wt. % to about 99 wt. % slurry catalyst.

The content of solids (kg/h) entering optional solid-liquid separation unit 108 via first pressurized slurry catalyst stream 106 is assumed to exit from optional solid-liquid separation unit 108 only via the retentate, i.e., first slurry catalyst stream 110. The amounts of solids contained in the retentate are mainly determined by the pore size of one or more filter membranes contained in the solid-liquid separation unit. For example, a size is selected in such a way to remove at least about 50%, or from about 65%, or from about 75 to about 80%, of the petroleum-based oil liquid carrier from first pressurized slurry catalyst stream 106.

First slurry catalyst stream 110 having a reduced content of petroleum-based oil liquid carrier is split into second slurry catalyst stream 102 and a third slurry catalyst stream 103.

System 100 further includes diafiltration separation units 124a, 124b and 124c. In this particular embodiment, system 100 is operated in a countercurrent mode, i.e., where incoming slurry catalyst stream 101 and incoming renewable-based liquid carrier stream 152 as discussed below enter system 100 on opposite ends to flow countercurrent to each other. However, this embodiment is merely illustrative and other modes such as a parallel mode as known in the art are also contemplated for use herein. In addition, although this embodiment describes diafiltration separation units, any cross-flow filtration separation unit such as the one described above can be used in the processes described herein.

Diafiltration refers to a cross-flow filtration process wherein a buffer material, e.g., a solvent, is added into the feed stream and/or the filtering process while the filtrate is removed continuously from the process. In one embodiment of diafiltration, the process is used for purifying retained large molecular weight species, increasing the recovery of low molecular weight species, buffer exchange and simply changing the properties of a given solution. Diafiltration can be in the form of batch diafiltration or continuous diafiltration. In batch diafiltration, the retentate is concentrated to the original volume or up to a certain concentration of the slurry catalyst in the retentate. Once this concentration is reached, another volume of feed stream is added. In continuous diafiltration, the volume of feed stream (solvent and incoming feed stream) is added to the filtration process at the same flow rate at which the filtrate and the retentate are being removed. By this method, the volume of the fluid in the process can be kept constant while the smaller molecules, e.g., heavy oil in solvent, which can permeate through the filter are washed away in the filtrate.

The operating temperature for diafiltration separation units 124a, 124b and 124c is the temperature of the stream entering the diafiltration separation unit as well as the pressure. In diafiltration separation units 124a, 124b and 124c, a solvent is requested and used as an extracting medium for the further extraction/separation of the petroleum-based oil liquid carrier from the slurry catalyst. In some embodiments, the solvent/extraction medium is a renewable solvent including, for example, xylene, benzene, toluene, ethanol and the like.

In some embodiments, examples of a filter membrane of diafiltration separation units 124a, 124b and 124c include those made of stainless steel 316, even though materials other than metals can be employed such as polymers, organic materials, inorganic ceramic materials, etc., as discussed above for optional solid-liquid separation unit 108. Diafiltration separation units 124a, 124b and 124c include a filter membrane that may have the same characteristics as the cross-flow filter membrane discussed above.

As previously mentioned, diafiltration is a particular form of “cross-flow filtration,” and it is generally performed in two stages: a first stage of concentration and a second stage wherein a volume of solvent is added to replace the volume of filtrate. In general, diafiltration separation unit 124a separates a second pressurized slurry catalyst stream 122 received from pump 120 as discussed below to provide a first slurry catalyst stream retentate 126 having a reduced content of petroleum-based oil liquid carrier, and a first mixture of petroleum-based oil liquid carrier and renewable-based liquid carrier permeate 128. In some embodiments, first slurry catalyst stream retentate 126 has a reduced content of petroleum-based oil liquid carrier relative to first slurry catalyst stream 110.

The solvent employed in the diafiltration process using diafiltration separation units 124a, 124b and 124c can be recovered by methods known in the art. For example, any solvent present in first petroleum-based oil liquid carrier and renewable-based liquid carrier may be recovered from first mixture of petroleum-based oil liquid carrier and renewable-based liquid carrier permeate 128 in a downstream distillation unit and reused. In addition, any solvent present in first slurry catalyst stream retentate 126 may be recovered from first slurry catalyst stream retentate 126 using a dryer in order to separate the solvent (reusable) from the solids. The operating temperature of the dryer depends on the boiling point of the solvent used in the diafiltration as extracting medium.

First slurry catalyst stream retentate 126 having a reduced content of petroleum-based oil liquid carrier is split into a second slurry catalyst stream retentate 116 and a third slurry catalyst stream retentate 118. Second slurry catalyst stream retentate 116 is combined with third slurry catalyst stream 103 from optional solid-liquid separation unit 108 and a second mixture of petroleum-based oil liquid carrier and renewable-based liquid carrier permeate 114 from diafiltration separation unit 124b for sending to a pump 120. In some embodiments, there will also be a pump (not shown) to move first mixture of petroleum-based oil liquid carrier and renewable-based liquid carrier permeate 128 in countercurrent flow against the slurry catalyst flow.

Pump 120 can be any suitable pump as discussed above for pump 104 for increasing the pressure of third slurry catalyst stream 103, second mixture of petroleum-based oil liquid carrier and renewable-based liquid carrier permeate 114 and second slurry catalyst stream retentate 116 for sending second pressurized slurry catalyst stream 122 to diafiltration separation unit 124a.

Diafiltration separation unit 124b separates a third pressurized slurry catalyst stream 138 received from a pump 136 as discussed below to provide a fourth slurry catalyst stream retentate 140 and second mixture of petroleum-based oil liquid carrier and renewable-based liquid carrier permeate 114 having a reduced renewable-based liquid carrier content relative to a third mixture of petroleum-based oil liquid carrier and renewable-based liquid carrier permeate 130 as discussed below. Fourth slurry catalyst stream retentate 140 will have a reduced content of petroleum-based oil liquid carrier relative to first slurry catalyst stream retentate 126.

Fourth slurry catalyst stream retentate 140 having a reduced content of petroleum-based oil liquid carrier is split into a fifth slurry catalyst stream retentate 132 and a sixth slurry catalyst stream retentate 134. Fifth slurry catalyst stream retentate 132 is combined with third slurry catalyst stream retentate 118 from diafiltration separation unit 124a and third mixture of petroleum-based oil liquid carrier and renewable-based liquid carrier permeate 130 from diafiltration separation unit 124c for sending to pump 136.

Pump 136 can be any suitable pump as discussed above for pump 104 for increasing the pressure of third slurry catalyst stream retentate 118, third mixture of petroleum-based oil liquid carrier and renewable-based liquid carrier permeate 130 and fifth slurry catalyst stream retentate 132 for sending third pressurized slurry catalyst stream 138 to diafiltration separation unit 124b.

Diafiltration separation unit 124c separates a fourth pressurized slurry catalyst stream 144 received from a pump 142 to provide a seventh slurry catalyst stream retentate 150 enriched in the renewable-based liquid carrier and having substantially no content of petroleum-based oil liquid carrier and third mixture of petroleum-based oil liquid carrier and renewable-based liquid carrier permeate 130 having a reduced renewable-based liquid carrier content relative to seventh slurry catalyst stream retentate 150 and renewable-based liquid carrier stream 162.

Seventh slurry catalyst stream retentate 150 is enriched in the renewable-based liquid carrier while having substantially no content of petroleum-based oil liquid carrier present in the slurry catalyst stream retentate. In some embodiments, seventh slurry catalyst stream retentate 150 will have less than about 5 wt. % of petroleum-based oil liquid carrier. In some embodiments, seventh slurry catalyst stream retentate 150 comprising solid particles and the renewable-based liquid carrier can contain from about 60 wt. % to about 98 wt. % renewable-based liquid carrier and from about 2 wt. % to about 40 wt. % solid particles.

Seventh slurry catalyst stream retentate 150 is split into an eighth slurry catalyst stream retentate 146 and a ninth slurry catalyst stream retentate 148. Eighth slurry catalyst stream retentate 146 is combined with sixth slurry catalyst stream retentate 134 from diafiltration separation unit 124b and renewable-based liquid carrier stream 162 for sending to pump 142. Ninth slurry catalyst stream retentate 148 enriched in the renewable-based liquid carrier is thereafter sent to be used in, for example, a slurry hydroconversion process using one or more renewable feedstocks.

Pump 142 can be any suitable pump as discussed above for pump 104 for increasing the pressure of sixth slurry catalyst stream retentate 134, eighth slurry catalyst stream retentate 146 and renewable-based liquid carrier stream 162 for sending fourth pressurized slurry catalyst stream 144 to diafiltration separation unit 124c. Renewable-based liquid carrier stream 162 includes incoming renewable-based liquid carrier stream 152 and a renewable-based liquid carrier effluent 160 as discussed below.

System 100 further includes a separation unit 154 for receiving first mixture of petroleum-based oil liquid carrier and renewable-based liquid carrier permeate 128. Separation unit 154 separates the petroleum-based oil liquid carrier from the renewable-based liquid carrier to generate renewable-based liquid carrier effluent 160 and a second petroleum-based oil liquid carrier rich effluent 156. Separation unit 154 can be any suitable separation unit such as a liquid-liquid separation unit for separating the petroleum-based oil liquid carrier from the renewable-based liquid carrier. In some embodiment, separation unit 154 can be a distillation column, a fractionator or any other suitable separation unit for separating the petroleum-based oil liquid carrier from the renewable-based liquid carrier with different boiling points.

Second petroleum-based oil liquid carrier rich effluent 156 exits separation unit 154 and is combined with first petroleum-based oil liquid carrier rich effluent 112 to generate a third petroleum-based oil liquid carrier rich effluent 158. Third petroleum-based oil liquid carrier rich effluent 158 is thereafter sent for further processing or discarded. Renewable-based liquid carrier effluent 160 exits separation unit 154 and is combined with incoming renewable-based liquid carrier stream 152 to generate renewable-based liquid carrier stream 162.

In some embodiments, incoming renewable-based liquid carrier stream 152 can be any renewable-based liquid carrier capable of being mixed with the petroleum-based oil liquid carrier to form a mixture of petroleum-based oil liquid carrier and renewable-based liquid carrier permeate as discussed above. In this manner, the renewable-based liquid carrier can be effectively separated from the petroleum-based oil liquid carrier in separation unit 154 and reused in system 100. In some embodiments, incoming renewable-based liquid carrier stream 152 can be a renewable-based liquid carrier having a boiling point lower than the boiling point of the petroleum-based oil liquid carrier in incoming slurry catalyst stream 101. In some embodiments, the petroleum-based oil liquid carrier in incoming slurry catalyst stream 101 can have a first boiling point and incoming renewable-based liquid carrier stream 152 can have a second boiling point less than the first boiling point. In some embodiments, the petroleum-based oil liquid carrier in incoming slurry catalyst stream 101 can have a boiling point greater than 500° F., e.g., greater than 500° F. and up to about 1125° F., or from about 550° F. to about 1100° F., or from about 550° F. to about 950° F.

In some embodiments, incoming renewable-based liquid carrier stream 152 can have a boiling point less than 500° F., e.g., a boiling point ranging from about 100° F. and up to about 495° F., or from about 200° F. to about 495° F., or from about 300° F. to about 495° F. Suitable renewable-based liquid carriers for incoming renewable-based liquid carrier stream 152 include, for example, a renewable naphtha or kero product from a hydroconversion process using a renewable feedstock, renewable gasoline, sustainable aviation fuels (SAF), or a light product produced from a slurry process.

FIG. 2 illustrates a non-limiting illustrative alternative embodiment of a system 200. In this particular embodiment, a petroleum-based oil liquid carrier present in an incoming slurry catalyst stream 201 as discussed below cannot be mixed with a renewable-based liquid carrier present in an incoming renewable-based liquid carrier stream 252 as discussed below. System 200 includes at least a solid-liquid separation unit 208, diafiltration separation units 224a, 224b and 224c and pumps 204, 220, 236 and 242. It is to be understood that system 200 including at least solid-liquid separation unit 208, diafiltration separation units 224a, 224b and 224c and pumps 204, 220, 236 and 242 is not limited to the configuration of the embodiments shown in FIG. 2, and other configurations are contemplated herein. In particular, although three diafiltration separation units and three pumps are shown in system 200, this is merely illustrative and other configurations are contemplated herein. For example, in non-limiting illustrative embodiments, system 200 may contain from one to five diafiltration separation units. In addition, it is further contemplated that in some embodiments, system 200 may not include solid-liquid separation unit 208.

In some embodiments, incoming slurry catalyst stream 201 comprising solid particles and a petroleum-based oil liquid carrier can contain from about 60 wt. % to about 98 wt. % petroleum-based oil liquid carrier and from about 2 wt. % to about 40 wt. % solid particles. In some embodiments, incoming slurry catalyst stream 201 is received from a separation unit (not shown) following a slurry hydroconversion process in a slurry hydroconversion reactor unit including at least a heavy oil feedstock, or directly from a slurry hydroconversion reactor unit. In general, a slurry hydroconversion process uses a dispersed catalyst which can be continuously doped into the feed. In some embodiments, the catalyst can correspond to one or more catalytically active metals in particulate form and/or supported on particles. In some embodiments, the slurry hydroconversion catalyst may be a precursor thereof.

In some embodiments, the slurry catalyst and the petroleum-based oil liquid carrier for incoming slurry catalyst stream 201 can be any of the slurry catalyst and discussed above for incoming slurry catalyst stream 101.

Incoming slurry catalyst stream 201 including a petroleum-based oil liquid carrier is combined with a second slurry catalyst stream 202 received from solid-liquid separation unit 208 as discussed below for sending to a pump 204. Pump 204 can be any suitable pump for increasing the pressure of incoming slurry catalyst stream 201 and second slurry catalyst stream 202 for sending a first pressurized slurry catalyst stream 206 to solid-liquid separation unit 208. For example, pump 204 may be a rotary pump including an impeller, or alternatively may be any other suitable fluid pump. In some embodiments, pump 204 is a large recirculation pump for providing crossflow filtration.

Solid-liquid separation unit 208 separates first pressurized slurry catalyst stream 206 including petroleum-based oil liquid carrier to provide a first slurry catalyst stream 210 having a reduced content of petroleum-based oil liquid carrier (i.e., a solid-rich stream comprising solid catalyst particles and solids formed during a hydroconversion reaction with a remaining amount of petroleum-based oil liquid carrier) and a first petroleum-based oil liquid carrier rich effluent 212 (i.e., a solid-free lean stream). A “solid-rich stream” is intended herein to identify a liquid, slurry, or solid stream that contains most if not all the amounts of solids (e.g., 99%) contained in first pressurized slurry catalyst stream 206 entering solid-liquid separation unit 208. A “solid-free lean stream” is intended herein to identify a liquid or liquid stream containing negligible amounts of solids, generally lower than about 1000 ppm, or lower than about 100 ppm, e.g., from about 10 ppm to about 1000 ppm solids. In some embodiments, there will also be a pump (not shown) to move first petroleum-based oil liquid carrier rich effluent 212 in countercurrent flow against the slurry catalyst flow.

In some embodiments, the solids can be separated from first pressurized slurry catalyst stream 206 using conventional techniques such as, for example, centrifugation, sedimentation or gravity settling, filtering, or any other suitable separator or combination of separators.

In some embodiments, solid-liquid separation unit 208 carries out a solid-liquid separation process comprising a filtration process or step as discussed above for optional solid-liquid separation unit 108 such as a cross-flow filtration device. In one embodiment, the filtration assembly comprises between two to ten filtration units. In another embodiment, at least four to eight filtration units.

In one embodiment, solid-liquid separation unit 208, e.g., a cross-flow filtration device, used in the illustrative embodiments described herein concentrates the solid content from an initial concentration of about 5 wt. % to about 12 wt. % of first pressurized slurry catalyst stream 206, up to about 20 wt. % to about 25% by weight of first slurry catalyst stream 210 having a reduced content of petroleum-based oil liquid carrier as the outlet stream (retentate) while obtaining first petroleum-based oil liquid carrier rich effluent 212 as an outlet cleaned stream containing relatively little to no solid content. In some embodiments, first petroleum-based oil liquid carrier rich effluent 212 will contain at least about 90% of the petroleum-based oil liquid carrier relative to first pressurized slurry catalyst stream 206. In some embodiments, first petroleum-based oil liquid carrier rich effluent 212 will contain at least about 95% of the petroleum-based oil liquid carrier relative to first pressurized slurry catalyst stream 206. In some embodiments, first petroleum-based oil liquid carrier rich effluent 212 will contain at least about 99% of the petroleum-based oil liquid carrier relative to first pressurized slurry catalyst stream 206.

In some embodiments, first slurry catalyst stream 210 including a reduced content of petroleum-based oil liquid carrier can contain from about 1 wt. % to about 10 wt. % petroleum-based oil liquid carrier and from about 90 wt. % to about 99 wt. % slurry catalyst.

The content of solids (kg/h) entering solid-liquid separation unit 208 via first pressurized slurry catalyst stream 206 is assumed to exit from solid-liquid separation unit 208 only via the retentate, i.e., first slurry catalyst stream 210. The amounts of solids contained in the retentate are mainly determined by the pore size of one or more filter membranes contained in the solid-liquid separation unit. For example, a size is selected in such a way to remove at least about 50%, or from about 65%, or from about 75% to about 80%, of the petroleum-based oil liquid carrier from first pressurized slurry catalyst stream 206.

First slurry catalyst stream 210 having a reduced content of petroleum-based oil liquid carrier is split into second slurry catalyst stream 202 and a third slurry catalyst stream 203.

System 200 further includes diafiltration separation units 224a, 224b and 224c. In this particular embodiment, system 200 is operated in a countercurrent mode, i.e., where incoming slurry catalyst stream 201 and an incoming renewable-based liquid carrier stream 252 as discussed below enter system 200 on opposite ends to flow countercurrent to each other. However, this embodiment is merely illustrative and other modes such as a parallel mode as known in the art are also contemplated for use herein.

The operating temperature for diafiltration separation units 224a, 224b and 224c is the temperature of the stream entering the diafiltration separation unit as well as the pressure. In diafiltration separation units 224a, 224b and 224c, a solvent is requested and used as an extracting medium for the further extraction/separation of the petroleum-based oil liquid carrier from the slurry catalyst. In some embodiments, the solvent/extraction medium can be a composition including a light specific gravity solvent or solvent mixtures, such as, for example, xylene, benzene, toluene, kerosene, reformate (light aromatics), light naphtha, heavy naphtha, light cycle oil (LCO), medium cycle oil (MCO), propane, and diesel boiling range material, which is used to “wash” the feed stream to the deoiling zone.

In some embodiments, examples of a filter membrane of diafiltration separation units 224a, 224b and 224c include those made of stainless steel 316, even though materials other than metals can be employed such as polymers, organic materials, inorganic ceramic materials, etc., as discussed above for solid-liquid separation unit 208. Diafiltration separation units 224a, 224b and 224c include a filter membrane that may have the same characteristics as the cross-flow filter membrane discussed above.

In general, diafiltration separation unit 224a separates a second pressurized slurry catalyst stream 222 received from pump 220 as discussed below to provide a first slurry catalyst stream retentate 226 having a reduced content of petroleum-based oil liquid carrier, and a first mixture of petroleum-based oil liquid carrier and renewable-based liquid carrier permeate 228. In some embodiments, first slurry catalyst stream retentate 226 will have a reduced content of petroleum-based oil liquid carrier relative to first slurry catalyst stream 210.

The solvent employed in the diafiltration process using diafiltration separation units 224a, 224b and 224c can be recovered by methods known in the art. For example, any solvent present in first petroleum-based oil liquid carrier and renewable-based liquid carrier may be recovered from first mixture of petroleum-based oil liquid carrier and renewable-based liquid carrier permeate 228 in a downstream distillation unit and reused. In addition, any solvent present in first slurry catalyst stream retentate 226 may be recovered from first slurry catalyst stream retentate 226 using a dryer in order to separate the solvent (reusable) from the solids. The operating temperature of the dryer depends on the boiling point of the solvent used in the diafiltration as extracting medium.

First slurry catalyst stream retentate 226 having a reduced content of petroleum-based oil liquid carrier is split into a second slurry catalyst stream retentate 216 and a third slurry catalyst stream retentate 218. Second slurry catalyst stream retentate 216 is combined with third slurry catalyst stream 203 from solid-liquid separation unit 208 and a second mixture of petroleum-based oil liquid carrier and renewable-based liquid carrier permeate 214 from diafiltration separation unit 224b for sending to a pump 220. In some embodiments, there will also be a pump (not shown) to move first mixture of petroleum-based oil liquid carrier and renewable-based liquid carrier permeate 228 in countercurrent flow against the slurry catalyst flow.

Pump 220 can be any suitable pump as discussed above for pump 204 for increasing the pressure of third slurry catalyst stream 203, second mixture of petroleum-based oil liquid carrier and renewable-based liquid carrier permeate 214 and second slurry catalyst stream retentate 216 for sending second pressurized slurry catalyst stream 222 to diafiltration separation unit 224a.

Diafiltration separation unit 224b separates a third pressurized slurry catalyst stream 238 received from pump 236 as discussed below to provide a fourth slurry catalyst stream retentate 240 and second mixture of petroleum-based oil liquid carrier and renewable-based liquid carrier permeate 214 having a reduced renewable-based liquid carrier content relative to a third mixture of petroleum-based oil liquid carrier and renewable-based liquid carrier permeate 230 as discussed below. Fourth slurry catalyst stream retentate 240 will have a reduced content of petroleum-based oil liquid carrier relative to first slurry catalyst stream retentate 226.

Fourth slurry catalyst stream retentate 240 having a reduced content of petroleum-based oil liquid carrier is split into a fifth slurry catalyst stream retentate 232 and a sixth slurry catalyst stream retentate 234. Fifth slurry catalyst stream retentate 232 is combined with third slurry catalyst stream retentate 218 from diafiltration separation unit 224a and third mixture of petroleum-based oil liquid carrier and renewable-based liquid carrier permeate 230 from diafiltration separation unit 224c for sending to a pump 236.

Pump 236 can be any suitable pump as discussed above for pump 204 for increasing the pressure of third slurry catalyst stream retentate 218, third mixture of petroleum-based oil liquid carrier and renewable-based liquid carrier permeate 230 and fifth slurry catalyst stream retentate 232 for sending third pressurized slurry catalyst stream 238 to diafiltration separation unit 224b.

Diafiltration separation unit 224c separates a fourth pressurized slurry catalyst stream 244 received from a pump 242 to provide a seventh slurry catalyst stream retentate 250 enriched in the renewable-based liquid carrier and having no content of petroleum-based oil liquid carrier and third mixture of petroleum-based oil liquid carrier and renewable-based liquid carrier permeate 230 having a reduced renewable-based liquid carrier content relative to renewable-based liquid carrier stream 262.

Seventh slurry catalyst stream retentate 250 is enriched in the renewable-based liquid carrier while having substantially no content of petroleum-based oil liquid carrier present in the slurry catalyst stream retentate. In some embodiments, seventh slurry catalyst stream retentate 250 will have less than about 5 wt. % of petroleum-based oil liquid carrier. In some embodiments, seventh slurry catalyst stream retentate 250 comprising solid particles and the renewable-based liquid carrier can contain from about 60 wt. % to about 98 wt. % renewable-based liquid carrier and from about 2 wt. % to about 40 wt. % solid particles.

Seventh slurry catalyst stream retentate 250 is split into an eighth slurry catalyst stream retentate 246 and a ninth slurry catalyst stream retentate 248. Eighth slurry catalyst stream retentate 246 is combined with sixth slurry catalyst stream retentate 234 from diafiltration separation unit 224b and renewable-based liquid carrier stream 262 for sending to pump 242. Ninth slurry catalyst stream retentate 248 enriched in the renewable-based liquid carrier is thereafter sent to be used in, for example, a slurry hydroconversion process using a renewable feedstock.

Pump 242 can be any suitable pump as discussed above for pump 204 for increasing the pressure of sixth slurry catalyst stream retentate 234, eighth slurry catalyst stream retentate 246 and renewable-based liquid carrier stream 262 for sending fourth pressurized slurry catalyst stream 244 to diafiltration separation unit 224c. Renewable-based liquid carrier stream 262 includes incoming renewable-based liquid carrier stream 252 and a renewable-based liquid carrier effluent 260 as discussed below.

System 200 further includes a liquid-liquid separation unit 254 for receiving first mixture of petroleum-based oil liquid carrier and renewable-based liquid carrier permeate 228. Liquid-liquid separation unit 254 separates the petroleum-based oil liquid carrier from the renewable-based liquid carrier to generate renewable-based liquid carrier effluent 260 and a second petroleum-based oil liquid carrier rich effluent 256. Liquid-liquid separation unit 254 can be any suitable liquid-liquid separation unit for separating the petroleum-based oil liquid carrier from the renewable-based liquid carrier. As will be discussed below, in this illustrative embodiment the petroleum-based oil liquid carrier will have a first density, and the renewable-based liquid carrier will have a second density greater than the first density. Based on the density difference, the renewable-based liquid carrier can be separated from the petroleum-based oil liquid carrier and exit from the bottom of liquid-liquid separation unit 254 as renewable-based liquid carrier effluent 260. The petroleum-based oil liquid carrier will exit from the top of liquid-liquid separation unit 254 as second petroleum-based oil liquid carrier rich effluent 256.

Second petroleum-based oil liquid carrier rich effluent 256 exits liquid-liquid separation unit 254 and is combined with first petroleum-based oil liquid carrier rich effluent 212 to generate a third petroleum-based oil liquid carrier rich effluent 258. Third petroleum-based oil liquid carrier rich effluent 258 is thereafter sent for further processing or discarded. Renewable-based liquid carrier effluent 260 exits liquid-liquid separation unit 254 and is combined with incoming renewable-based liquid carrier stream 252 to generate renewable-based liquid carrier stream 262.

In some embodiments, incoming renewable-based liquid carrier stream 252 can be any renewable-based liquid carrier capable of not being mixed with the petroleum-based oil liquid carrier to form the petroleum-based oil liquid carrier and renewable-based liquid carrier permeates discussed above. In this manner, the renewable-based liquid carrier can be effectively separated from the petroleum-based oil liquid carrier in liquid-liquid separation unit 254 by a density difference and reused in system 200. In some embodiments, incoming renewable-based liquid carrier stream 252 can be a renewable-based liquid carrier having a weight greater than a weight of the petroleum-based oil liquid carrier in incoming slurry catalyst stream 201. Suitable renewable-based liquid carriers for incoming renewable-based liquid carrier stream 252 include, for example, a bio-alcohol. In some embodiments a bio-alcohol includes, for examples bioethanol, bio-glycerol, biobutanediol, bio-ethylene glycol and the like.

According to one aspect of the present disclosure, a process, comprises:
converting, in one or more cross-flow filtration separation units, a slurry catalyst comprising solid particles and a petroleum-based oil liquid carrier to a slurry catalyst comprising solid particles and a renewable-based liquid carrier, wherein the slurry catalyst comprising solid particles and the renewable-based liquid carrier comprises less than about 5 wt. % of the petroleum-based oil liquid carrier.

In an illustrative embodiment, as may be combined with one or more of the preceding paragraphs, the slurry catalyst comprising solid particles and the petroleum-based oil liquid carrier comprises from about 60 wt. % to about 98 wt. % of the petroleum-based oil liquid carrier and from about 2 wt. % to about 40 wt. % of the solid particles.

In an illustrative embodiment, as may be combined with one or more of the preceding paragraphs, the one or more cross-flow filtration separation units comprise one to five diafiltration separation units.

In an illustrative embodiment, as may be combined with one or more of the preceding paragraphs, the one to five diafiltration separation units are operated in a countercurrent mode.

In an illustrative embodiment, as may be combined with one or more of the preceding paragraphs, the one to five diafiltration separation units are operated in a parallel mode.

In an illustrative embodiment, as may be combined with one or more of the preceding paragraphs, at least 90% of the petroleum-based oil liquid carrier has a boiling point greater than 500° F. and the renewable-based liquid carrier has a boiling point less than 500° F.

In an illustrative embodiment, as may be combined with one or more of the preceding paragraphs, the petroleum-based oil liquid carrier has a first density and the renewable-based liquid carrier has a second density greater than the first density.

In an illustrative embodiment, as may be combined with one or more of the preceding paragraphs, the slurry catalyst comprising solid particles and the renewable-based liquid carrier comprises no content of the petroleum-based oil liquid carrier.

According to another aspect of the present disclosure, a continuous process for converting an incoming slurry catalyst comprising solid particles and a petroleum-based oil liquid carrier to a slurry catalyst comprising solid particles and a renewable-based liquid carrier, comprises:
generating, in a last diafiltration separation unit of a series of diafiltration separation units comprising three to five diafiltration separation units, a first retentate comprising the slurry catalyst comprising solid particles and a first amount of the renewable-based liquid carrier and a permeate comprising a mixture of the petroleum-based oil liquid carrier and a second amount of the renewable-based liquid carrier,
wherein the generating comprises passing, through the last diafiltration separation unit, a pressurized stream comprising (i) a second retentate derived from the other diafiltration separation units, the second retentate comprising the slurry catalyst comprising solid particles and a reduced content of the petroleum-based oil liquid carrier relative to the incoming slurry catalyst comprising solid particles and the petroleum-based oil liquid carrier, (ii) a recycled retentate comprising a portion of the first retentate comprising the slurry catalyst comprising solid particles and the first amount of the renewable-based oil liquid carrier received from the last diafiltration separation unit and (iii) an incoming stream comprising the renewable-based liquid carrier to generate the first retentate.

In an illustrative embodiment, as may be combined with one or more of the preceding paragraphs, the incoming stream comprising the slurry catalyst comprising solid particles and the petroleum-based oil liquid carrier comprises from about 60 wt. % to about 98 wt. % of the petroleum-based oil liquid carrier and from about 2 wt. % to about 40 wt. % of the solid particles.

In an illustrative embodiment, as may be combined with one or more of the preceding paragraphs, the first retentate comprises no content of the petroleum-based oil liquid carrier.

In an illustrative embodiment, as may be combined with one or more of the preceding paragraphs, the three to five diafiltration separation units are operated in a countercurrent mode.

In an illustrative embodiment, as may be combined with one or more of the preceding paragraphs, the three to five diafiltration separation units are operated in a parallel mode.

In an illustrative embodiment, as may be combined with one or more of the preceding paragraphs, at least 90% of the petroleum-based oil liquid carrier has a boiling point greater than 500° F. and the renewable-based liquid carrier has a boiling point less than 500° F.

In an illustrative embodiment, as may be combined with one or more of the preceding paragraphs, the continuous process further comprises passing the permeate comprising a mixture of the petroleum-based oil liquid carrier and the renewable-based liquid carrier to a separation unit comprising one of a distillation unit and a fractionation unit to separate the petroleum-based oil liquid carrier from the renewable-based liquid carrier based on a difference in the boiling point of the petroleum-based oil liquid carrier and the boiling point of the renewable-based liquid carrier.

In an illustrative embodiment, as may be combined with one or more of the preceding paragraphs, the separated renewable-based liquid carrier is recycled and reused with the incoming stream comprising the renewable-based liquid carrier.

In an illustrative embodiment, as may be combined with one or more of the preceding paragraphs, the petroleum-based oil liquid carrier has a first density and the renewable-based liquid carrier has a second density greater than the first density.

In an illustrative embodiment, as may be combined with one or more of the preceding paragraphs, the continuous process further comprises passing the permeate comprising a mixture of the petroleum-based oil liquid carrier and the renewable-based liquid carrier to a liquid-liquid separation unit to separate the petroleum-based oil liquid carrier from the renewable-based liquid carrier based on the density difference of the petroleum-based oil liquid carrier and the renewable-based liquid carrier.

In an illustrative embodiment, as may be combined with one or more of the preceding paragraphs, the separated renewable-based liquid carrier is recycled and reused with the incoming stream comprising the renewable-based liquid carrier.

According to another aspect of the present disclosure, a system, comprises:
one or more cross-flow filtration separation units configured to convert a slurry catalyst comprising solid particles and a petroleum-based oil liquid carrier to a slurry catalyst comprising solid particles and a renewable-based liquid carrier, wherein the slurry catalyst comprising solid particles and the renewable-based liquid carrier comprises less than about 5 wt. % of the petroleum-based oil liquid carrier.

In an illustrative embodiment, as may be combined with one or more of the preceding paragraphs, the one or more cross-flow filtration separation units comprise three to five diafiltration separation units, wherein the last diafiltration separation unit is configured to generate a retentate comprising the slurry catalyst comprising solid particles and a first amount of the renewable-based liquid carrier and a permeate comprising a mixture of the petroleum-based oil liquid carrier and a second amount of the renewable-based liquid carrier.

In an illustrative embodiment, as may be combined with one or more of the preceding paragraphs, the one to five diafiltration separation units are operated in a countercurrent mode.

In an illustrative embodiment, as may be combined with one or more of the preceding paragraphs, the one to five diafiltration separation units are operated in a parallel mode.

In an illustrative embodiment, as may be combined with one or more of the preceding paragraphs, the first retentate comprises no content of the petroleum-based oil liquid carrier.

In an illustrative embodiment, as may be combined with one or more of the preceding paragraphs, at least 90% of the petroleum-based oil liquid carrier has a boiling point greater than 500° F. and the renewable-based liquid carrier has a boiling point less than 500° F.

In an illustrative embodiment, as may be combined with one or more of the preceding paragraphs, the system further comprises a separation unit comprising one of a distillation unit and a fractionation unit to separate the petroleum-based oil liquid carrier from the renewable-based liquid carrier based on a difference in the boiling point of the petroleum-based oil liquid carrier and the boiling point of the renewable-based liquid carrier.

In an illustrative embodiment, as may be combined with one or more of the preceding paragraphs, the system further comprises a liquid-liquid separation unit to separate the petroleum-based oil liquid carrier from the renewable-based liquid carrier based on the density difference of the petroleum-based oil liquid carrier and the renewable-based liquid carrier.

In an illustrative embodiment, as may be combined with one or more of the preceding paragraphs, the separated renewable-based liquid carrier is recycled and reused with the incoming stream comprising the renewable-based liquid carrier.

In an illustrative embodiment, as may be combined with one or more of the preceding paragraphs, the petroleum-based oil liquid carrier has a first density and the renewable-based liquid carrier has a second density greater than the first density.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A process, comprising:
converting, in one or more cross-flow filtration separation units, a slurry catalyst comprising solid particles and a petroleum-based oil liquid carrier to a slurry catalyst comprising solid particles and a renewable-based liquid carrier, wherein the slurry catalyst comprising solid particles and the renewable-based liquid carrier comprises less than about 5 wt. % of the petroleum-based oil liquid carrier.

2. The process according to claim 1, wherein the slurry catalyst comprising solid particles and the petroleum-based oil liquid carrier comprises from about 60 wt. % to about 98 wt. % of the petroleum-based oil liquid carrier and from about 2 wt. % to about 40 wt. % of the solid particles.

3. The process according to claim 1, wherein the one or more cross-flow filtration separation units comprise one to five diafiltration separation units.

4. The process according to claim 3, wherein the one to five diafiltration separation units are operated in a countercurrent mode.

5. The process according to claim 3, wherein the one to five diafiltration separation units are operated in a parallel mode.

6. The process according to claim 1, wherein at least 90% of the petroleum-based oil liquid carrier has a boiling point greater than 500° F. and the renewable-based liquid carrier has a boiling point less than 500° F.

7. The process according to claim 1, wherein the petroleum-based oil liquid carrier has a first density and the renewable-based liquid carrier has a second density greater than the first density.

8. The process according to claim 1, wherein the slurry catalyst comprising solid particles and the renewable-based liquid carrier comprises no content of the petroleum-based oil liquid carrier.

9. A continuous process for converting an incoming slurry catalyst comprising solid particles and a petroleum-based oil liquid carrier to a slurry catalyst comprising solid particles and a renewable-based liquid carrier, comprising:
generating, in a last diafiltration separation unit of a series of diafiltration separation units comprising three to five diafiltration separation units, a first retentate comprising the slurry catalyst comprising solid particles and a first amount of the renewable-based liquid carrier and a permeate comprising a mixture of the petroleum-based oil liquid carrier and a second amount of the renewable-based liquid carrier;
wherein the generating comprises passing, through the last diafiltration separation unit, a pressurized stream comprising (i) a second retentate derived from the other diafiltration separation units, the second retentate comprising the slurry catalyst comprising solid particles and a reduced content of the petroleum-based oil liquid carrier relative to the incoming slurry catalyst comprising solid particles and the petroleum-based oil liquid carrier, (ii) a recycled retentate comprising a portion of the first retentate comprising the slurry catalyst comprising solid particles and the first amount of the renewable-based oil liquid carrier received from the last diafiltration separation unit and (iii) an incoming stream comprising the renewable-based liquid carrier to generate the first retentate.

10. The continuous process according to claim 9, wherein the incoming stream comprising the slurry catalyst comprising solid particles and the petroleum-based oil liquid carrier comprises from about 60 wt. % to about 98 wt. % of the petroleum-based oil liquid carrier and from about 2 wt. % to about 40 wt. % of the solid particles.

11. The continuous process according to claim 9, wherein the first retentate comprises no content of the petroleum-based oil liquid carrier.

12. The continuous process according to claim 9, wherein the three to five diafiltration separation units are operated in a countercurrent mode.

13. The continuous process according to claim 9, wherein at least 90% of the petroleum-based oil liquid carrier has a boiling point greater than 500° F. and the renewable-based liquid carrier has a boiling point less than 500° F.

14. The continuous process according to claim 13, further comprising passing the permeate comprising a mixture of the petroleum-based oil liquid carrier and the renewable-based liquid carrier to a separation unit comprising one of a distillation unit and a fractionation unit to separate the petroleum-based oil liquid carrier from the renewable-based liquid carrier based on a difference in the boiling point of the petroleum-based oil liquid carrier and the boiling point of the renewable-based liquid carrier.

15. The continuous process according to claim 14, wherein the separated renewable-based liquid carrier is recycled and reused with the incoming stream comprising the renewable-based liquid carrier.

16. The continuous process according to claim 9, wherein the petroleum-based oil liquid carrier has a first density and the renewable-based liquid carrier has a second density greater than the first density.

17. The continuous process according to claim 16, further comprising passing the permeate comprising a mixture of the petroleum-based oil liquid carrier and the renewable-based liquid carrier to a liquid-liquid separation unit to separate the petroleum-based oil liquid carrier from the renewable-based liquid carrier based on the density difference of the petroleum-based oil liquid carrier and the renewable-based liquid carrier, thereby generating a separated renewable-based liquid carrier.

18. The continuous process according to claim 17, wherein the separated renewable-based liquid carrier is recycled and reused with the incoming stream comprising the renewable-based liquid carrier.

19. A system, comprising:
one or more cross-flow filtration separation units configured to convert a slurry catalyst comprising solid particles and a petroleum-based oil liquid carrier to a slurry catalyst comprising solid particles and a renewable-based liquid carrier, wherein the slurry catalyst comprising solid particles and the renewable-based liquid carrier comprises less than about 5 wt. % of the petroleum-based oil liquid carrier.

20. The system according to claim 19, wherein the one or more cross-flow filtration separation units comprise three to five diafiltration separation units, wherein the last diafiltration separation unit is configured to generate a retentate comprising the slurry catalyst comprising solid particles and a first amount of the renewable-based liquid carrier and a permeate comprising a mixture of the petroleum-based oil liquid carrier and a second amount of the renewable-based liquid carrier.
